(19) United States
(12) Patent Application Publication
(10) Pub. No.: US 2014/0352483 A1
(43) Pub. Date: Dec. 4, 2014

(54) REMOTE ALIGNMENT TOOL

(71) Applicant: General Electric Company, Schenectady, NY (US)

(72) Inventors: Herbert Chidsey Robert, III, Simpsonville, SC (US); Glenn Curtis Taxacher, Simpsonville, SC (US)

(21) Appl. No.: 13/909,654

(22) Filed: Jun. 4, 2013

(51) Int. Cl. F16C 1/10

(52) U.S. Cl. CPC F16C 1/106
USPC 74/500.5

(57) ABSTRACT

A remote alignment system and a remote alignment tool for aligning a plurality of remotely operated tools are disclosed. In an embodiment, the alignment tool includes at least two sleeves. An exterior surface of each of the at least two sleeves is affixed to an exterior surface of an adjacent sleeve of the at least two sleeves. A tool retainer is disposed on an inner surface of each of the at least two sleeves for selectively retaining at least an axial position of a remote tool relative to the sleeve.

### GOVERNMENT LICENSE RIGHTS

This invention was made with Government support under contract number DE-FC26-05NT42643 awarded by the Department of Energy. The government has certain rights in the invention.

### BACKGROUND OF THE INVENTION

The invention relates generally to remote inspection and repair of turbomachines, and more particularly, to an alignment tool for aligning a plurality of inspection and/or repair tools for concurrent use at a work site.

Many types of industrial machines such as turbines, include critical components which are encased within an external casing or shell. During the life cycle of a machine, these critical components require inspection, repair, or maintenance in order to maximize the lifespan of the parts and the machine as a whole. Traditionally, access to components for inspection, repair or maintenance has been obtained by removing the casing and disassembling the machine as needed. This process can be technically difficult, time consuming, labor intensive, and expensive. Disassembly of the machine incurs costs both in labor required to disassemble the machine and casing, and in non-productive down time for the machine. Disassembly of the casing of the machine also exposes moving parts of the machine, creating a potential hazard for operators.

As an alternative to disassembly, industrial machines such as turbines may be inspected using a flexible remote viewing device that is inserted through a port in the machine's casing. The port permits an external inspector to feed a directionally controllable viewing device into a wide range of locations to optically view the internal components of the machine.

Repair tools may also be inserted into the machine through the port in a similar fashion. However, in order to perform useful work, the repair tool may be required to be inserted concurrently with, and maintain substantial alignment with, a viewing device so that a remote operator can visualize the work site.

Port size in the casing limits the number and size of devices which can be inserted into a machine at a given time. Further, repair tools, in the course of carrying out useful work, may transmit rotational or axial-based forces which may cause migration of the repair tool relative to a remote viewing device and the work site. This may cause the repair tool and the viewing device to come out of alignment, such that the remote operator can no longer view the work being done by the repair tool.

### BRIEF DESCRIPTION OF THE INVENTION

A first aspect of the disclosure provides a remote tool alignment system for aligning at least two remotely operated tools. The remote alignment system includes a remote alignment tool having at least two sleeves. An exterior surface of each of the at least two sleeves is affixed to an exterior surface of an adjacent sleeve of the at least two sleeves. A remote tool is positioned in each sleeve, wherein each remote tool includes a flexible cable passing through each sleeve to a proximal end thereof.

A second aspect of the disclosure provides an alignment tool for aligning a plurality of remotely operated tools. The alignment tool includes at least two sleeves, an exterior surface of each of the at least two sleeves being affixed to an exterior surface of an adjacent sleeve of the at least two sleeves. A tool retainer is disposed on an inner surface of each of the at least two sleeves for selectively retaining at least an axial position of a remote tool relative to the sleeve.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1 shows a perspective view of an alignment tool in accordance with embodiments of the disclosure.

FIGS. 2-4 show cross-sectional views of an alignment tool in accordance with embodiments of the disclosure.

FIG. 5 shows a side view of an alignment tool in accordance with embodiments of the disclosure.

FIG. 6 shows a side view of a remote alignment system in accordance with embodiments of the disclosure.

FIG. 7 shows a cross sectional view of portion of a remote alignment tool in accordance with an embodiment of the invention.

FIG. 8 shows a cross sectional view along section A-A (shown in FIG. 7) of a remote alignment tool in accordance with an embodiment of the invention.

FIG. 9 shows a cross sectional view of portion of a remote alignment tool in accordance with an embodiment of the invention.

FIG. 10 shows a cross sectional view along section A-A (shown in FIG. 9) of a remote alignment tool in accordance with an embodiment of the invention.

FIG. 11 shows a cross sectional view of portion of a remote alignment tool in accordance with an embodiment of the invention.

FIG. 12 shows a cross sectional view along section A-A (shown in FIG. 11) of a remote alignment tool in accordance with an embodiment of the invention.

FIG. 13 shows a cross sectional view of portion of a remote alignment tool in accordance with an embodiment of the invention.

FIG. 14 shows a cross sectional view along section A-A (shown in FIG. 13) of a remote alignment tool in accordance with an embodiment of the invention.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

At least one embodiment of the present invention is described below in reference to its application in connection with and operation of a turbomachine in the form of a gas turbine. Further, at least one embodiment of the present invention is described below in reference to a nominal size and including a set of nominal dimensions. However, it should be apparent to those skilled in the art and guided by the teachings herein that embodiments of the present invention are likewise applicable to any suitable industrial machine such as, e.g., other types of turbines, engines, etc. Further, it should be apparent to those skilled in the art and guided by the teachings herein that embodiments of the present invention are likewise applicable to various scales of the nominal size and/or nominal dimensions.

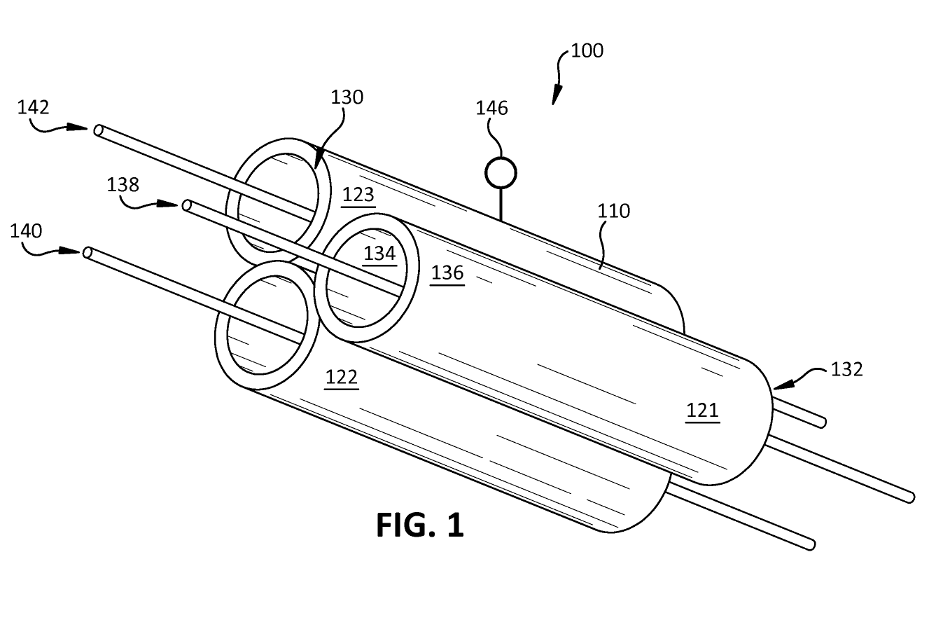

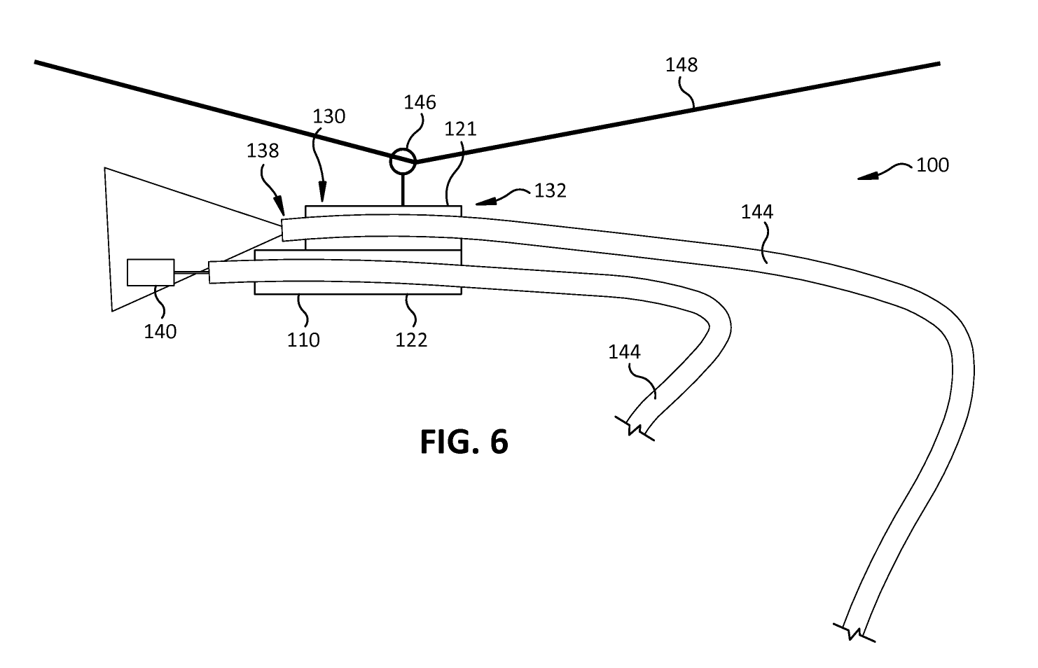

Turning to the drawings, FIGS. 1-14 illustrate various aspects of a remote alignment system 100 (FIGS. 1, 6) including a remote alignment tool 110 (FIGS. 1-14) for aligning a plurality of remote tools for performing work, e.g., at a site physically remote from the tool operator. The work site may be, e.g., on a component on an interior of an industrial machine.

Referring to FIGS. 1 and 6, a remote alignment system 100 is disclosed for aligning a plurality of remotely operated tools.

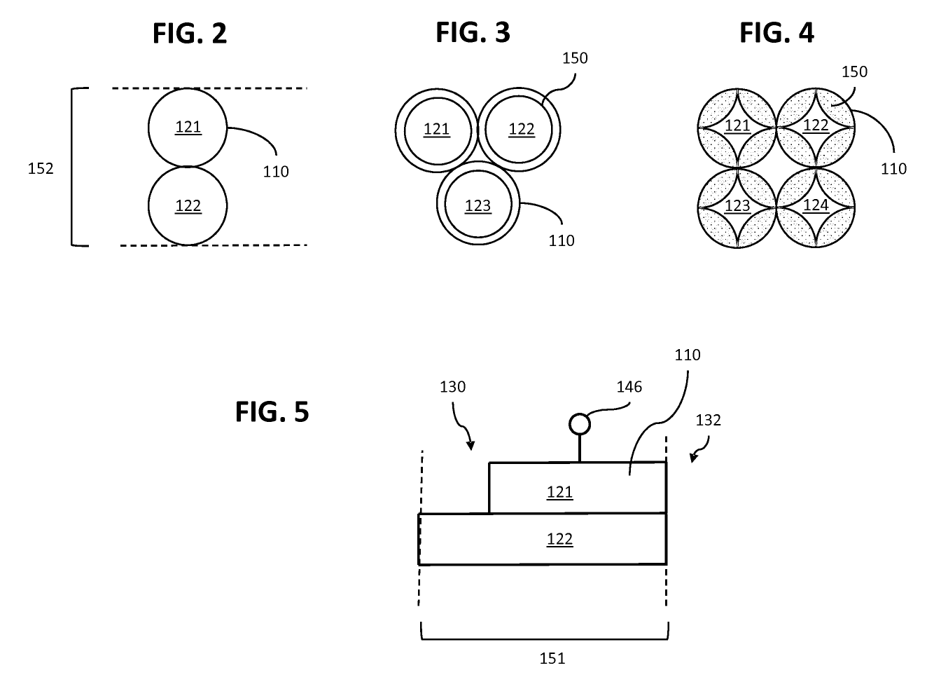

Remote alignment system 100 includes a remote alignment tool 110 that includes at least two sleeves, e.g., first sleeve 121 and second sleeve 122. As shown in FIG. 1, each sleeve includes a distal end 130, a proximal end 132, an inner surface 134, and an exterior surface 136. As shown, exterior surface 136 of each of the at least two sleeves is affixed to an exterior surface 136 of an adjacent sleeve. For example, FIG. 2 shows exterior surface 136 of first sleeve 121 affixed to exterior surface 136 of second sleeve 122. In some embodiments, such as shown in FIGS. 1 and 3, remote alignment tool 110 may additionally include a third sleeve 123. In these embodiments, exterior surface 136 of first sleeve 121 is affixed to the exterior surfaces 136 of each of second sleeve 122 and third sleeve 123. Similarly, the exterior surfaces 136 of each of second sleeve 122 and third sleeve 123 are similarly affixed to the exterior surfaces 136 of each of the other two sleeves that make up remote alignment tool 110. In still further embodiments, as shown in FIG. 4, remote alignment tool 110 may also include a fourth sleeve 124, which is configured in a similar fashion. Regardless of the number of sleeves included in remote alignment tool 110, remote alignment tool 110 may be configured to bundle the sleeves in such a fashion as to minimize the cross-sectional width 152 (FIG. 2) of the remote alignment tool 110. In some embodiments, such as shown in FIG. 4, each sleeve need not contact or be affixed to each other sleeve.

Remote alignment system 100 may further include a remote tool positioned in each sleeve. As shown in FIG. 1, in various embodiments, there may be as many remote tools 138, 140, 142 as there are sleeves 121, 122, 123. A first remote tool 138 may be positioned in first sleeve 121 such that the first remote tool 138 is disposed at a distal end 130 of first sleeve 121. Each remote tool 138, 140, 142 may include a flexible cable 144 (FIG. 6) which passes through the respective sleeve 121, 122, 123 to a proximal end 132 thereof. Thus, first remote tool 138 is disposed within first sleeve 121, with the operative portion of first tool 138 being disposed at the distal end 130 thereof (FIG. 6). Second remote tool 140 may be similarly situated with respect to second sleeve 122, and third remote tool 142 may be situated similarly with respect to third sleeve 123. Embodiments having a fourth remote tool (not shown) may be situated similarly with respect to fourth sleeve 124 (FIG. 4), and so on.

Each of the remote tools 138, 140, 142 etc. disposed within remote alignment tool 110 may be independently selected for inclusion in remote alignment system 100 based on the maintenance or repair task at hand. In various embodiments, remote tools 138, 140, 142 may be inserted into remote alignment tool 110 prior to insertion into an industrial machine, such that remote alignment system 100 may be inserted into an industrial machine already assembled for performance of the desired task. In other embodiments, remote alignment tool 110 may be inserted into the industrial machine, and remote tools 138, 140, 142 may be guided to and inserted into remote alignment tool 110 in place. In this manner, remote tools 138, 140, 142 may also be swapped for other tools should that be desired after insertion. Once inserted, each of remote tools 138, 140, 142 may be independently controlled. Remote alignment tool 110 may be radially insertable into a turbomachine via, e.g., a port.

For example, in the embodiment shown in FIG. 6, first remote tool 138 disposed in first sleeve 121 may be a directionally controlled viewing device, such as, e.g., a borescope. Second remote tool 140 disposed in second sleeve 122 (FIG. 6), as well as third remote tool 142 and any additional remote tools (not shown in FIG. 6) may each be, e.g., a vacuum tool, an applicator tool for applying a substance such as, e.g., lubricant, paint, or other coatings to a work area, a magnet, a grinding tool for grinding a surface, or a rotary or oscillating tool for smoothing a surface. In one embodiment, for example, first tool 138 may be a visual inspection device for visualizing the work field, second tool 140 may be a grinding tool, and third tool 142 may be a vacuum tool for vacuuming any particulate matter or dust generated by the grinding tool. These three tools may be placed and maintained in alignment by remote alignment tool 110 and remote alignment system 100 so that a remotely located operator can operate each of the grinding and vacuum tools while maintaining a visual contact with the work field.

In various embodiments, the dimensions of remote alignment tool 110 may vary. In some embodiments, remote alignment tool 110 may have a maximum cross sectional width 152 of about 40 mm (FIG. 2). In particular, the cross sectional width 152 of the remote alignment tool 110 may be, e.g., about 30 mm to about 40 mm. Each sleeve 121, 122, 123, 124 may have a cross sectional diameter of about 8 to about 15 mm in some embodiments. Further, in some embodiments, remote alignment tool may have an axial length 151 (FIG. 5) of about 5 cm to about 10 cm.

In some embodiments, the sleeves may be metal, and may particularly be, for example, extruded aluminum, stainless steel, or titanium. In other embodiments, the sleeves may be made of a non-metal material. In particular, the sleeves may be made of, e.g., organic composite or plastic. In various embodiments, the sleeves may be affixed to one another using an adhesive such as, e.g., epoxy, mechanical fasteners such as, e.g., rivets, or external banding such as straps made of, e.g., nylon or metal, or an adhesive covered strap such as, e.g., cloth- or scrim-backed pressure-sensitive tape.

As shown in FIGS. 3-4, each sleeve of first, second, third, and fourth (as applicable) sleeves 121, 122, 123, 124 includes a tool retainer 150 disposed on the inner surface 134 thereof. Tool retainer 150 selectively retains a position of a remote tool relative to the respective sleeve. In particular, in various embodiments, tool retainer 150 may retain an axial position of, e.g., remote tool 138 relative to first sleeve 121. This in turn maintains an axial position relationship between the various tools 138, 140 (FIG. 6) and any other tools present, such that, for example, second tool 140 remains aligned with the visual field displayed by a viewing device first tool 138. This axial position relationship may be maintained regardless of forces exerted through the use of various types of second tools 140 (again referring to FIG. 6), for example, torque generated by a grinding tool, pushback axial force generated by an applicator tool, etc.

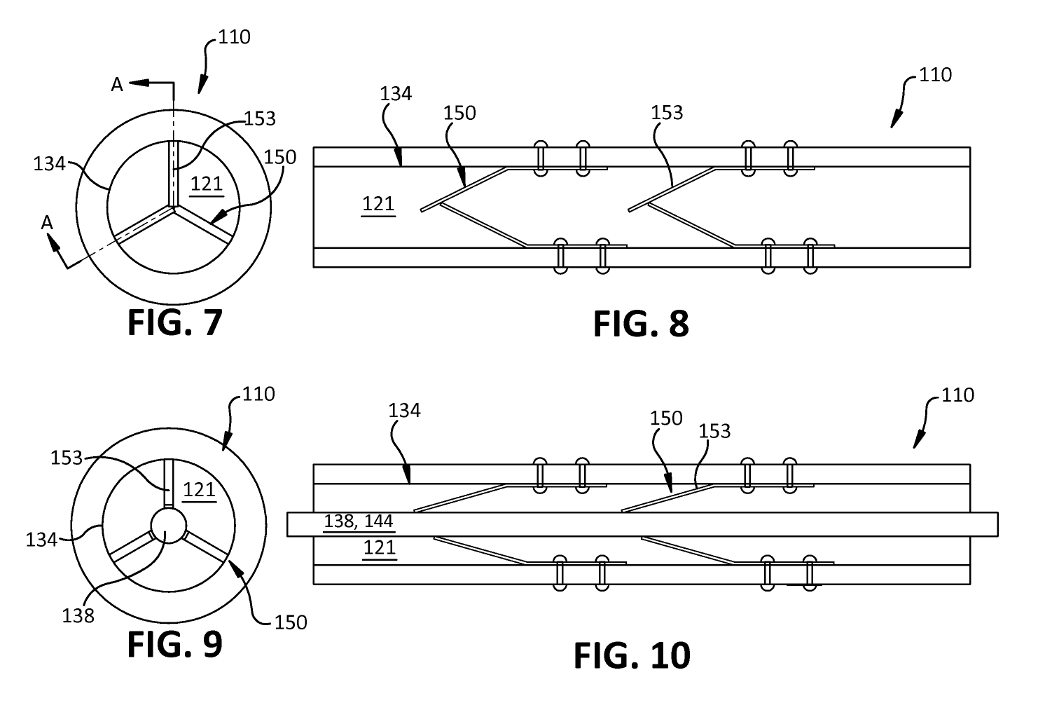

In various embodiments, tool retainer 150 may be one of a pneumatic system, a hydraulic system, and a spring system. As shown in FIGS. 7-10, in embodiments in which tool retainer 150 is a spring system, tool retainer 150 may include one or more micro-springs 153 affixed to an inner surface 134 of the applicable sleeve 121 (or 122, 123, 124, not shown). FIGS. 7-8 illustrate a position of micro-springs 153 prior to insertion of remote tool 138 in first sleeve 121 according to one embodiment of the invention. After insertion of first remote tool 138 into first sleeve 121 of remote alignment tool 110, as shown in FIGS. 9-10, micro-springs 153 contract to mechanically grip first remote tool 138 and substantially fix the position of first remote tool 138 in first sleeve 121.

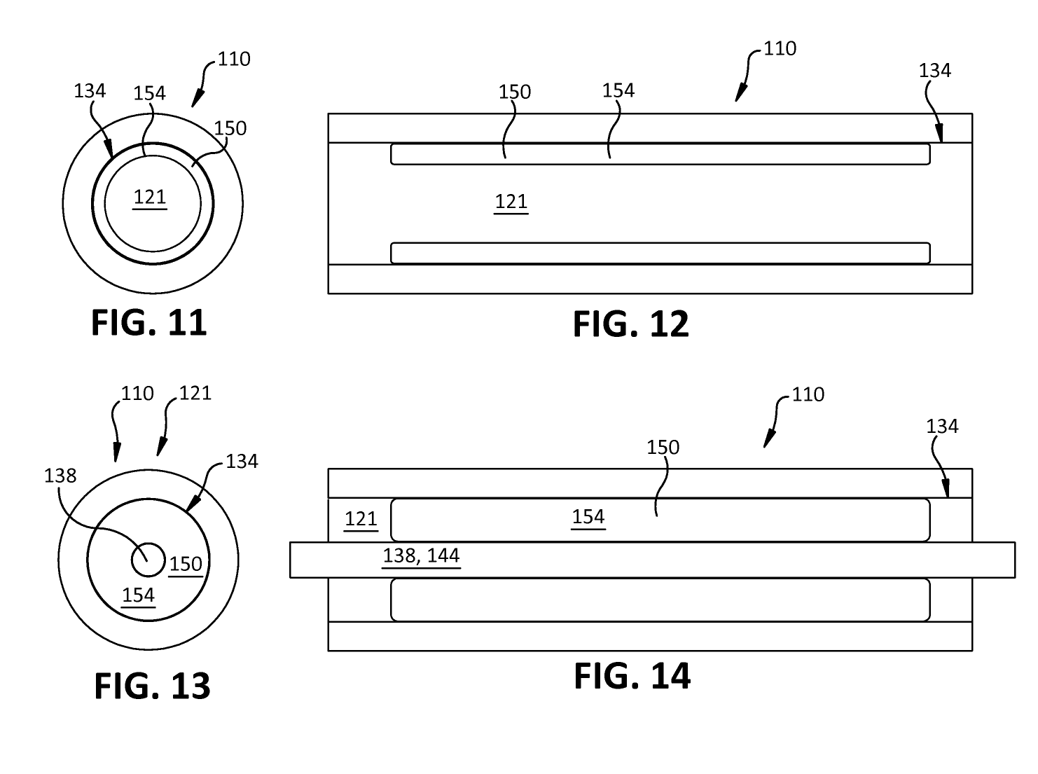

As shown in FIGS. 11-14, in embodiments in which tool retainer 150 is a pneumatic or hydraulic retention system, tool retainer 150 may include a retaining sleeve 154 affixed to inner surface 134 of the applicable sleeve 121 (or 122, 123, 124, not shown). Retaining sleeve 154 may be made of, e.g., a flexible rubber or polymer in various embodiments. Prior to insertion of first remote tool 138, as shown in FIGS. 11-12, retaining sleeve 154 may be substantially empty. After insertion of first remote tool 138, as shown in FIGS. 13-14, retaining sleeve 154 may be filled, either with a fluid in a hydraulic system or a gas in a pneumatic system, in a fashion similar to an inflatable bladder. The inflation of retaining sleeve 154 mechanically grips first remote tool 138, substantially fixing its position with respect to first sleeve 121.

Regardless of the type of tool retainer used, tool retainer 150 substantially fixes the position of first remote tool 138 relative to first sleeve 121 in remote alignment device 110 for the duration of use. To remove tool 138 from first sleeve 121, micro-springs 153 (FIGS. 7-10) may be relaxed, or turgor pressure in retaining pressure 154 (FIG. 11-14) may be released, allowing first tool 138 to slide out of first sleeve 121. It is noted that the foregoing tool retainers 150 are discussed and described relative to first sleeve 121 and first remote tool 138 in the interest of simplicity and brevity only. Each of second sleeve 122, third sleeve 123, and fourth sleeve 124, as applicable to a given embodiment of remote alignment tool 110, may include an analogous tool retainer 150.

As shown in FIGS. 5-6, remote alignment tool 110 may further include a coupling fixture 146 disposed on the exterior surface 136 of at least one of the first through fourth sleeves 121, 122, 123, 124 (as applicable; third and fourth sleeves 123, 124 not shown). Coupling fixture 146 may be, e.g., an eyelet. Coupling fixture 146 may be used to suspend the alignment tool.

As shown in FIG. 6, remote alignment system 100 may further include a suspension system 148 for suspending remote alignment tool 110 using the coupling fixture 146. Suspension system 148 may include a cable or system of cables, or similar system for locating and positioning the remote alignment tool 110 within a turbomachine.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A remote tool alignment system comprising:
a remote alignment tool including:
at least two sleeves,
an exterior surface of each of the at least two sleeves being affixed to an exterior surface of an adjacent sleeve of the at least two sleeves; and
a remote tool positioned in each sleeve,
wherein each remote tool includes a flexible cable passing through each sleeve to a proximal end thereof.

2. The remote alignment system of claim 1, wherein the at least two sleeves further comprises three sleeves.

3. The remote alignment system of claim 1, wherein the at least two sleeves further comprises four sleeves.

4. The remote alignment system of claim 1, further comprising a coupling fixture disposed on the exterior surface of at least one of the at least two sleeves for suspending the remote alignment tool.

5. The remote alignment tool of claim 4, further comprising a suspension system for suspending the remote alignment tool using the coupling fixture and locating the remote alignment tool within a turbomachine.

6. The remote alignment system of claim 1, wherein the remote alignment tool further comprises:
a tool retainer disposed on an inner surface of each of the at least two sleeves for selectively retaining at least an axial position of the remote tool relative to the sleeve,
wherein the tool retainer includes one of:
a pneumatic system, a hydraulic system, and a spring system.

7. The remote alignment system of claim 1, wherein the remote alignment tool has a maximum width of about 40 mm.

8. The remote alignment system of claim 1, wherein the remote alignment tool further comprises one of aluminum, stainless steel, or titanium.

9. The remote alignment system of claim 1, wherein the remote alignment tool further comprises one of an organic composite and a plastic.

10. The remote alignment system of claim 1, wherein each of the remote tools disposed in each of the at least two sleeves is independently controlled.

11. The remote alignment system of claim 1, wherein a first remote tool disposed in a first sleeve of the at least two sleeves further comprises a directionally controlled viewing device, and
wherein a second remote tool disposed in a second sleeve of the at least two sleeves further comprises one of:
a vacuum tool,
an applicator tool for applying a substance to a work area,
a magnet,
a grinding tool for grinding a surface, or
a rotary or oscillating tool for smoothing a surface.

12. The remote alignment system of claim 1, wherein the remote alignment system is radially insertable into a turbomachine.

13. An alignment tool for aligning a plurality of remotely operated tools, the alignment tool comprising:
at least two sleeves,
an exterior surface of each of the at least two sleeves being affixed to an exterior surface of an adjacent sleeve of the at least two sleeves; and
a tool retainer disposed on an inner surface of each of the at least two sleeves for selectively retaining at least an axial position of a remote tool relative to the sleeve.

14. The alignment tool of claim 13, wherein the tool retainer includes one of:
a pneumatic system, a hydraulic system, and a spring system.

15. The alignment tool of claim 13, wherein the at least two sleeves further comprises three sleeves.

16. The alignment tool of claim 13, wherein the at least two sleeves further comprises four sleeves.

17. The alignment tool of claim 13, further comprising a coupling fixture disposed on the exterior surface of at least one of the at least two sleeves for suspending the alignment tool.

18. The alignment tool of claim 13, wherein the alignment tool has a maximum width of about 40 mm.

19. The alignment tool of claim 13, wherein each of the at least two sleeves further comprises one of aluminum, stainless steel, or titanium.

20. The alignment tool of claim 13, wherein each of the at least two sleeves further comprises one of an organic composite and a plastic.
